(19) United States
(12) Patent Application Publication
(10) Pub. No.: US 2008/0199685 A1
(43) Pub. Date: Aug. 21, 2008

(54) SPRAY SELF ASSEMBLY

(76) Inventors: Michael Jeremiah Bortner, Blacksburg, VA (US); David Fuch Wood, Christiansburg, VA (US); Elizabeth Gladwin, Christiansburg, VA (US)

Correspondence Address: SHERR & NOURSE, PLLC, 620 HERNDON PARKWAY, SUITE 200, HERNDON, VA, 20170, US

(21) Appl. No.: 12/035,283

(22) Filed: Feb. 21, 2008

Related U.S. Application Data
(63) Continuation-in-part of application No. 10/774,683, filed on Feb. 10, 2004, now Pat. No. 7,396,569.
(60) Provisional application No. 60/446,124, filed on Feb. 10, 2003.
(60) Provisional application No. 60/890,966, filed on Feb. 21, 2007.

(51) Int. Cl. B32B 5/16; B05D 1/12

(52) U.S. Cl. 428/328; 427/180; 428/323

(57) ABSTRACT

An apparatus (and a method of making an apparatus) that includes a flexible functional material. The flexible functional material includes nano-particle layer(s) and linking agent layer(s). The nano-particle layer(s) are bonded to the linking agent layer(s). The nano-particle layer(s) and/or linking agent layer(s) are deposited by being sprayed. Since nano-particle layer(s) and/or linking agent layer(s) may be deposited by being sprayed, a flexible functional material may be easily formed on structures (e.g. such as external aircraft parts) to create a conductive surface. Through spraying, deposition may be efficient and effective and allow for implementations which are impractical and/or not possible with bulk metal materials.

The present application is a continuation-in-part of pending U.S. patent application Ser. No. 10/774,683 (filed Feb. 10, 2004), which claims priority to U.S. Provisional Patent Application No. 60/446,124 (filed Feb. 10, 2003), which is hereby incorporated by reference in its entirety. The present application claims priority to U.S. Provisional Patent Application No. 60/890,966 (filed Feb. 21, 2007), which is hereby incorporated by reference in its entirety.

### BACKGROUND

Conductive materials (e.g. gold, copper, silver, etc.) are used in many technological applications. For example metals are used as wires to transmit electricity. In similar examples, sheets of metal are used to transfer heat, protect against electromagnetic radiation (e.g. radio waves), antennas, and many other applications. However, conductive materials have traditionally been in the form of a bulk metal (e.g. a piece of gold or copper) that is purified and formed in a specific shape based on the application. These traditional conductive materials do not have flexible properties. Accordingly, traditional conductive materials have limited applications based on their natural rigid form and composition. Traditional conductive materials can not be easily formed in flexible sheets or sprayed on surfaces and maintain the same, similar, and/or superior conductivity properties as bulk metal. For example, traditional conductive materials can not be sprayed on external aircraft parts to create a conductive surface.

### SUMMARY

Embodiments relate to an apparatus (and a method of making an apparatus) that includes a flexible functional material. The flexible functional material includes nano-particle layer(s) and linking agent layer(s). The nano-particle layer(s) are bonded to the linking agent layer(s). The nano-particle layer(s) and/or linking agent layer(s) are deposited by being sprayed. In accordance with embodiments, since nano-particle layer(s) and/or linking agent layer(s) may be deposited by being sprayed, a flexible functional material may be easily formed on structures (e.g. such as external aircraft parts) to create a conductive surface. In embodiments, through spraying, deposition may be efficient and effective and allow for implementations which are impractical and/or not possible with bulk metal materials.

In embodiments, a flexible functional material may include at least one nano-particle layer (e.g. including gold nano-clusters) and at least one linking agent layer. The at least one nano-particle layer is bonded to the at least one linking agent layer (e.g. through electrostatic and/or covalent bonding). Accordingly, the flexible functional material may be light weight, flexible, highly conductive, and/or easily conformable to a variety of structure by spray deposition, in accordance with embodiments.

### DRAWINGS

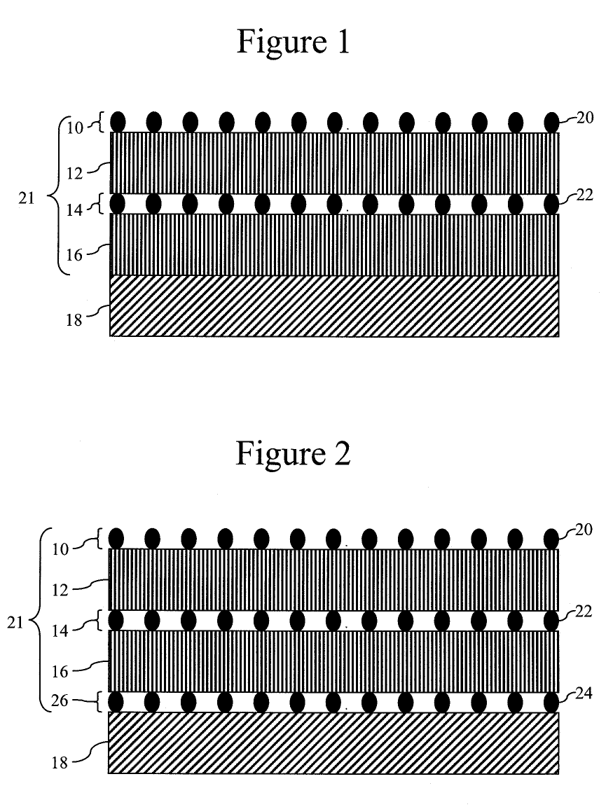

Example FIGS. 1 and 2 illustrate a flexible functional material formed on a base material, in accordance with embodiments.

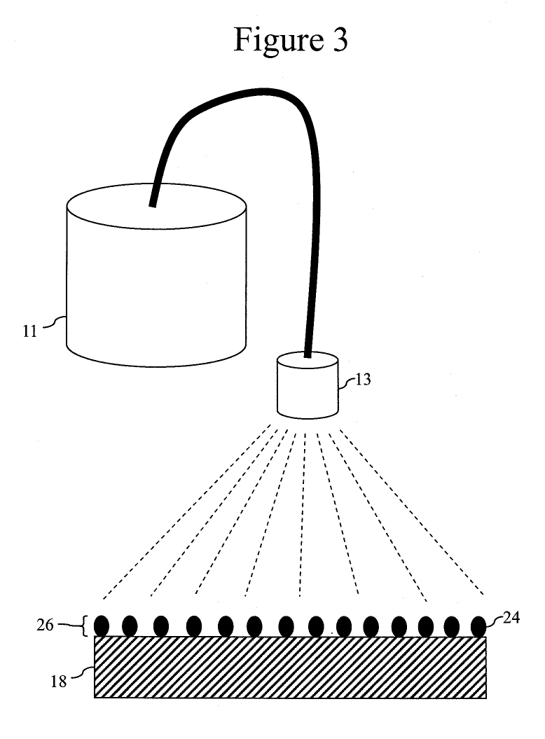

Example FIG. 3 illustrates deposition of a nano-particle layer on a base material by spraying, in accordance with embodiments.

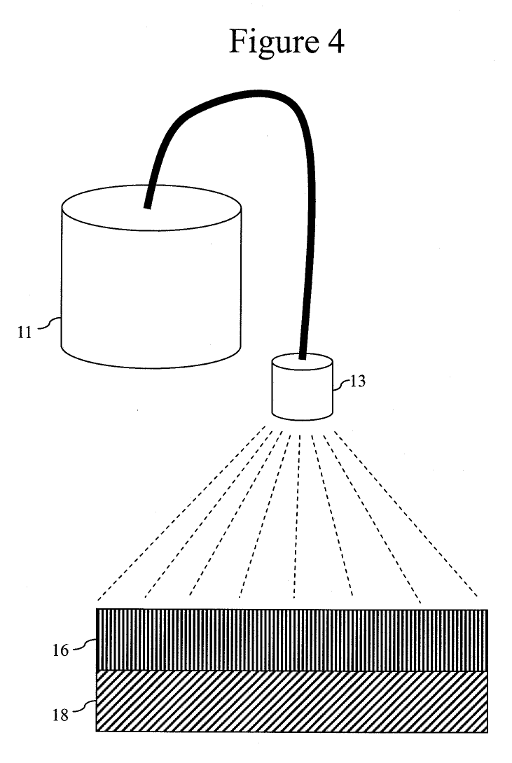

Example FIG. 4 illustrates deposition of a linking agent layer on a base material by spraying, in accordance with embodiments.

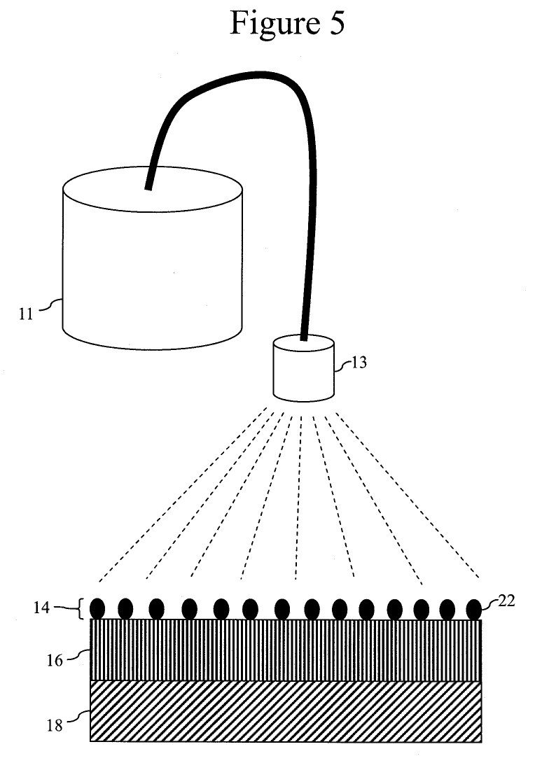

Example FIG. 5 illustrates deposition of a nano-particle layer on a linking agent layer by spraying, in accordance with embodiments.

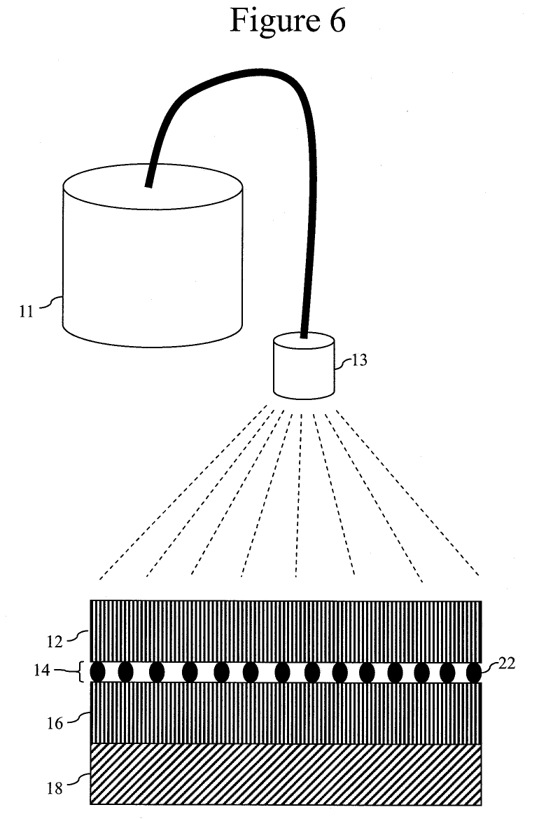

Example FIG. 6 illustrates deposition of a linking agent layer on a nano-particle layer by spraying, in accordance with embodiments.

### DESCRIPTION

Example FIG. 1 illustrates a flexible functional material 21 that includes a plurality of nano-particle layers 10, 14 and a plurality of inking agent layers 12, 16, in accordance with embodiments. The flexible functional material 21 may be formed on a base material 18, in accordance with embodiments. Flexible functional material 21 includes nano-size conductive particles 20, 22 that do not substantially deteriorate due to exercise of the flexibility of the flexible functional material.

In embodiments, a flexible functional material is a flexible conductive material that has conductive properties. However, in embodiments, a flexible function material may include materials that have other functional properties aside from conductivity (e.g. abrasion-resistance, reflectivity, etc.). In the embodiments discussed, nano-size conductive particles may be substituted with non-conductive nano-size particles that have functionality, such as ceramic nano-size particles that have abrasion resistant functionality.

First linking agent material layer 16 (of flexible functional material 21) may be bonded to base material 18. First linking agent material layer 16 may be also bonded to first nano-particle material layer 14. First nano-particle material layer 14 may be also bonded to second linking agent material layer 12. Second linking agent material layer 12 may be also bonded to second nano-particle material layer 10. Although only two linking agent layers (i.e. first linking agent material layer 16 and second linking agent material layer 12) and two nano-particle material layers (i.e. first nano-particle material layer 14 and second nano-particle material layer 10) are illustrated, embodiments may include any number of linking agent material layers and nano-particle material layers (including just one nano-particle material layer and/or linking agent material layer).

In embodiments, the flexible functional material 21 may be formed directly on the base material 18. The base material 21 may be substantially free standing, in embodiments. In embodiments, the base material 18 may be a flexible material (e.g. Mylar) or a substantially rigid material (e.g. a dome shaped polymer or a flat polymer).

First nano-particle material layer 14 includes nanoparticles 22. In embodiments, nano-particles 22 may be conductive nano-particles (e.g. nano-size gold clusters). Nano-particles 22 may be individually bonded to first linking agent material layer 16. Bonding of nano-particles 22 to first linking agent material layer 16 may be either electrostatic bonding and/or covalent bonding. Nano-particles 22 may not be substantially bonded to each other. Accordingly, as first linking agent material layer 16 expands or contracts, the bond between the nano-particles 22 and first linking agent material layer 16 is not significantly compromised.

Although nano-particles 22 in first nano-particle material layer 14 are not bonded to each other, nano-particles 22 may be arranged close enough to each other, such that they may be electrically coupled to each other. In other words, in embodiments, electrical current may flow between adjacent nano-particles 22 in first nano-particle material layer 14. In fact, in embodiments, the rate of electrical conduction (i.e. electrical resistance) in first nano-particle material layer 14 (e.g. including gold nano-clusters) may be comparable and/or exceed that of solid gold (due to lattice inefficiencies in solid gold).

Second linking agent material layer 12 may also be bonded to first nano-particle material layer 14, with the same or similar bonding mechanism as the bonding between first nano-particle material layer 14 and first linking agent material layer 16, in accordance with embodiments. In embodiments, first linking agent material layer 16 and second linking agent material layer 12 may include the same material and/or configuration. In embodiments, first linking agent material layer 16 and second linking agent material layer 12 may include different materials and/or configurations.

Second nano-particle material layer 10 may be bonded to second linking agent material layer 12 with the same or similar bonding mechanism as the bonding between first nano-particle material layer 14 and first linking agent layer 16. Additional linking agent material layer(s) and/or nano-particle material layer(s) may be formed over second nano-particle material layer 10, in accordance with embodiments. In embodiments, first nano-particle material layer 14 and second nano-particle material layer 10 may include the same material (i.e. nano-particles 20 and nano-particles 22 may be the same type of nano-particles) and/or configuration. In embodiments, first nano-particle material layer 14 and second nano-particle material layer 10 may include different materials (i.e. nano-particles 20 and nano-particles 22 may be different types of nano-particles) and/or configurations.

As illustrated in example FIG. 2, a nano-particle material layer (e.g. third nano-particle material layer 26 with nano-particles 24) may be formed between first linking agent layer 16 and flexible base material 18. In other words, in embodiments, a flexible base material may be bonded directly with a nano-particle material layer (e.g. third nano-particle material layer 26) or indirectly through a linking agent layer (e.g. first linking agent layer 18).

In embodiments, a base material and linking agent material layer(s) may have the same, similar, and/or compatible elastic properties. In other words, when flexible base material is deformed through stress, straining, or shrinking, the elasticity of linking agent material layer(s) may not prevent a flexible base material from deforming since it is elastically compatible with the flexible base material. Since nano-particle material layer(s) include individual nano-particles that are independently bonding to an adjacent flexible base material and/or linking agent material layer(s), nano-particle material layer(s) may not prevent a flexible base material from deforming, in accordance with embodiments. Further, during deformation of a flexible base material, nano-particle material layers may not be subjected to significant mechanical strain, since there is substantially no bonding between adjacent nano-particles in the nano-particle material layer(s), in accordance with embodiments.

Nano-particles (e.g. nano-particles 20, nano-particles 22, and/or nano-particles 24) may be formed through a self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials.

Through self assembly, nano-particles may be substantially uniformly and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a flexible base material). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thinkness that is approximately the diameter of the individual nano-particles. Through a self-assembly deposition method, nano-particles that do not bond to a host layer may be removed, so that a nano-particles material layer is formed that is relatively uniform in thinkness and material distribution.

Linking agent material layer(s) (e.g. first linking agent material layer 16 and/or second linking agent material layer 12) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, poly(diallyldimethylammonium chloride), and/or other similar materials. Linking agent material layer(s) may include materials that are polarized, in order for bonding with nano-particles, in accordance with embodiments.

In embodiments, linking agent material layer(s) may include a flexible material, an elastic material, and/or an elastomeric polymer. Accordingly, when nano-particles are bonded to sites of material in a linking agent material layer, then the nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is shrunk, stretched, strained, and/or deformed, bonded nano-particles will move with sites of the linking agent material layer to which they are bonded, thus avoiding any disassociation of the nano-particles from their host during deformation.

Note that the thicknesses in FIGS. 1-6 are shown for illustration and are not drawn to scale. In embodiments, the thickness of the flexible conductive layer is significantly less than the thickness of the base material. Accordingly, since the material in the base material and the flexible functional material are elastically compatible, deformation, shrinking, and/or stretching of the flexible base material cause the flexible functional material to comply and/or comply with the base material.

Example FIGS. 3-6 illustrate a pump 11 including a nozzle 13, in accordance with embodiments. Pump 11 may hold a liquid, with the liquid including particles (e.g. a colloid and/or solution of nano-particles and/or linking agent particles). Pump 11 may pressure the liquid resulting in the liquid spraying out of nozzle 13 is a relatively controlled manner. In embodiments, pump 11 is a centrifugal pump or an air powered diaphragm pump. However, one of ordinary skill in the art would appreciate other kinds of pumps (e.g. misters, spray cans, etc.) within the scope of this disclosure.

Example FIG. 3 illustrates deposition of a nano-particle layer on a base material by spraying, in accordance with embodiments. In embodiments, a nano-particle layer 26 may be deposited directly on a base material 18 by spraying a liquid including nano-particles 24. The liquid may be a colloid and/or solution that includes the nano-particles 24, such that when the liquid is sprayed on the base material 18 there is a relatively high consistency of interaction between the nano-particles 24 and the base material 18. This relatively high consistency of interaction may maximize the rate of physisorption and/or chemisorption of the nano-particles 24 to the base material 18. By maximizing the rate of physisorption and/or chemisorption, the nano-particles 24 may be consistently, effectively, and/or efficiently bonded on the base material 18. This consistent, effective, and efficient bonding may maximize the desirable properties (e.g. conductivity, abrasion resistance, thickness, elasticity, and other desirable properties) of a resulting flexible functional material, in accordance with embodiments.

In embodiments where nano-particles 24 are deposited on a base material 18 by other methods beside spraying (e.g. dipping base material 18 into a liquid including the nano-particles 24), interaction between the nano-particles 24 and the base material 18 may be more slow than when a liquid including the nano-particles 24 is sprayed on the base material 18. For example, if a base material 18 is dipped into a liquid including the nano-particles 24, the nano-particles 24 in the liquid close to the base material 18 bond to the base material 18. As a result, the concentration of nano-particles 24 in the liquid that is close to the base material 18 is depleted of nano-particles 24 (as they have been bonded to the base material 18). In order for more nano-particles 24 to interact with the base material 18, the concentration of nano-particles 24 in the liquid near the base material 18 needs to be replenished by reestablishing the concentration equilibrium of the nano-particles in the liquid near the base material 18. However, this reestablishment of the equilibrium and subsequent interaction takes some time.

However, in embodiments where a liquid including nano-particles 24 is sprayed onto base material 18, the time required to reestablish the concentration equilibrium of nano-particles 24 at the surface of the base material 18 is substantially nominal. In embodiments, since the liquid including nano-particles 24 is propelled by spraying onto the base material 18, there is substantially consistent and relatively rapid interaction of the nano-particles 24 and the base material 18, which resulting is relatively fast, efficient, and/or effective bonding of the nano-particles to the base material 18 to form the nano-particle layer 26. In other words, the sprayed liquid (including nano-particles 24) is a mechanism that substantially maximizes the interaction of nano-particles 24 with base material 18 by minimizing (or substantially eliminating) the negative effects of concentration equilibrium reestablishment (which is a significant factor in dipping embodiments).

Example FIG. 4 illustrates deposition of a linking agent layer on a base material by spraying, in accordance with embodiments. In embodiments, a linking agent layer 16 may be deposited directly on a base material 18 by spraying a liquid including linking agent particles (e.g. polymer strings). The liquid may be a colloid and/or solution that includes the linking agent particles, such that when the liquid is sprayed on the base material 18 there is a relatively high consistency of interaction between the linking agent particles and the base material 18. This relatively high consistency of interaction may maximize the rate of physisorption and/or chemisorption of the linking agent particles to the base material 18. By maximizing the rate of physisorption and/or chemisorption, the linking agent particles may be consistently, effectively, and/or efficiently bonded on the base material 18. This consistent, effective, and efficient bonding may maximize the desirable properties (e.g. conductivity, abrasion resistance, thickness, elasticity, and other desirable properties) of a resulting flexible functional material, in accordance with embodiments.

In embodiments where linking agent particles are deposited on a base material 18 by other methods beside spraying (e.g. dipping base material 18 into a liquid including the linking agent particles), interaction between the linking agent particles and the base material 18 may be more slow than when a liquid including the linking agent particles is sprayed on the base material 18. For example, if a base material 18 is dipped into a liquid including the linking agent particles, the linking agent particles in the liquid close to the base material 18 bond to the base material 18. As a result, the concentration of linking agent particles in the liquid that is close to the base material 18 is depleted of linking agent particles (as they have been bonded to the base material 18). In order for more linking agent particles to interact with the base material 18, the concentration of linking agent particles in the liquid near the base material 18 needs to be replenished by reestablishing the concentration equilibrium of the linking agent particles in the liquid near the base material 18. However, this reestablishment of the equilibrium and subsequent interaction takes some time.

However, in embodiments where a liquid including linking agent particles is sprayed onto base material 18, the time required to reestablish the concentration equilibrium of linking agent particles at the surface of the base material 18 is substantially nominal. In embodiments, since the liquid including linking agent particles is propelled by spraying onto the base material 18, there is substantially consistent and relatively rapid interaction of the linking agent particles and the base material 18, which resulting is relatively fast, efficient, and/or effective bonding of the linking agent particles to the base material 18 to form the linking agent layer 16. In other words, the sprayed liquid (including linking agent particles) is a mechanism that substantially maximizes the interaction of linking agent particles with base material 18 by minimizing (or substantially eliminating) the negative effects of concentration equilibrium reestablishment (which is a significant factor in dipping embodiments).

Example FIG. 5 illustrates deposition of a nano-particle layer on a linking agent layer by spraying, in accordance with embodiments. In embodiments, a nano-particle layer 14 may be deposited directly on a linking agent layer 16 by spraying a liquid including nano-particles 22. The liquid may be a colloid and/or solution that includes the nano-particles 22, such that when the liquid is sprayed on the linking agent layer 16 there is a relatively high consistency of interaction between the nano-particles 22 and the linking agent layer 16. This relatively high consistency of interaction may maximize the rate of physisorption and/or chemisorption of the nano-particles 22 to the linking agent layer 16. By maximizing the rate of physisorption and/or chemisorption, the nano-particles 22 may be consistently, effectively, and/or efficiently bonded on the linking agent layer 16. This consistent, effective, and efficient bonding may maximize the desirable properties (e.g. conductivity, abrasion resistance, thickness, elasticity, and other desirable properties) of a resulting flexible functional material, in accordance with embodiments.

In embodiments where nano-particles 22 are deposited on a linking agent layer 16 by other methods beside spraying (e.g. dipping base material 18 with bonded linking agent layer 16 into a liquid including the nano-particles 22), interaction between the nano-particles 22 and the linking agent layer 16 may be more slow than when a liquid including the nano-particles 22 is sprayed on the linking agent layer 16. For example, if a base material 18 bonded with linking agent layer 16 is dipped into a liquid including the nano-particles 22, the nano-particles 22 in the liquid close to the linking agent layer 16 bond to the base material 18. As a result, the concentration of nano-particles 22 in the liquid that is close to the linking agent layer 16 is depleted of nano-particles 22 (as they have been bonded to the linking agent layer 16). In order for more nano-particles 22 to interact with the linking agent layer 16, the concentration of nano-particles 22 in the liquid near the linking agent layer 16 needs to be replenished by reestablishing the concentration equilibrium of the nano-particles in the liquid near the linking agent layer 16. However, this reestablishment of the equilibrium and subsequent interaction takes some time.

However, in embodiments where a liquid including nano-particles 22 is sprayed onto linking agent layer 16, the time required to reestablish the concentration equilibrium of nano-particles 22 at the surface of the base material 18 is substantially nominal. In embodiments, since the liquid including nano-particles 22 is propelled by spraying onto the linking agent layer 16, there is substantially consistent and relatively rapid interaction of the nano-particles 22 and the linking agent layer 16, which resulting is relatively fast, efficient, and/or effective bonding of the nano-particles to the linking agent layer 16 to form the nano-particle layer 14. In other words, the sprayed liquid (including nano-particles 22) is a mechanism that substantially maximizes the interaction of nano-particles 22 with linking agent layer 16 by minimizing (or substantially eliminating) the negative effects of concentration equilibrium reestablishment (which is a significant factor in dipping embodiments).

Example FIG. 6 illustrates deposition of a linking agent layer on a nano-particle layer by spraying, in accordance with embodiments. In embodiments, a linking agent layer 12 may be deposited directly on a nano-particle layer 14 by spraying a liquid including linking agent particles (e.g. polymer strings). The liquid may be a colloid and/or solution that includes the linking agent particles, such that when the liquid is sprayed on the nano-particle layer 14 there is a relatively high consistency of interaction between the linking agent particles and the nano-particle layer 14. This relatively high consistency of interaction may maximize the rate of physisorption and/or chemisorption of the linking agent particles to the nano-particle layer 14. By maximizing the rate of physisorption and/or chemisorption, the linking agent particles may be consistently, effectively, and/or efficiently bonded on the nano-particle layer 14. This consistent, effective, and efficient bonding may maximize the desirable properties (e.g. conductivity, abrasion resistance, thickness, elasticity, and other desirable properties) of a resulting flexible functional material, in accordance with embodiments.

In embodiments where linking agent particles are deposited on a nano-particle layer 14 by other methods beside spraying (e.g. dipping nano-particle layer 14 into a liquid including the linking agent particles), interaction between the linking agent particles and the nano-particle layer 14 may be more slow than when a liquid including the linking agent particles is sprayed on the nano-particle layer 14. For example, if a nano-particle layer 14 is dipped into a liquid including the linking agent particles, the linking agent particles in the liquid close to the nano-particle layer 14 bond to the nano-particle layer 14. As a result, the concentration of linking agent particles in the liquid that is close to the nano-particle layer 14 is depleted of linking agent particles (as they have been bonded to the base material 18). In order for more linking agent particles to interact with the nano-particle layer 14, the concentration of linking agent particles in the liquid near the nano-particle layer 14 needs to be replenished by reestablishing the concentration equilibrium of the linking agent particles in the liquid near the nano-particle layer 14. However, this reestablishment of the equilibrium and subsequent interaction takes some time.

However, in embodiments where a liquid including linking agent particles is sprayed onto nano-particle layer 14, the time required to reestablish the concentration equilibrium of linking agent particles at the surface of the nano-particle layer 14 is substantially nominal. In embodiments, since the liquid including linking agent particles is propelled by spraying onto the nano-particle layer 14, there is substantially consistent and relatively rapid interaction of the linking agent particles and the nano-particle layer 14, which resulting is relatively fast, efficient, and/or effective bonding of the linking agent particles to the nano-particle layer 14 to form the linking agent layer 12. In other words, the sprayed liquid (including linking agent particles) is a mechanism that substantially maximizes the interaction of linking agent particles with nano-particle layer 14 by minimizing (or substantially eliminating) the negative effects of concentration equilibrium reestablishment (which is a significant factor in dipping embodiments).

In embodiments illustrated in FIGS. 3-6, in order to maximize the interaction of particles (e.g. nano-particles and/or linking agent particles) in a spray and the surface to which the particles interact (e.g. base material 18, linking agent layer 16, and/or nano-particle layer 14) the spray of the liquid should be tailored to substantially maximize the interaction of the particles with the surface, without destroying the particles or the surface. In embodiments, in order to maximize the interaction, the liquid should be propelled in a manner with a volume, velocity, duration, and/or distribution that forces as much contact of the particles as possible with the surface. However, in embodiments, the liquid should not be propelled with too much force that would damage either the particles or the surface.

In embodiments, the duration of spraying may be any amount of time. As examples, spraying may be performed for 2 seconds, minutes, and/or hours to accomplish the desired interaction. In embodiments, substantially maximizing the consistency of interaction comprises balancing orifice diameter of a spray nozzle, outlet angle of a spray nozzle, and time of deposition of the spray.

Embodiments relate to alternatives to traditional immersion coating technologies to fabricate films with control over deposition of individual material monolayers. Spray processing may be employed as a facile method to increase absorption and/or adsorption to the substrate surface and enhance the fabrication of homogenous individual material monolayers. The result may reduce processing times, significantly lower material quantity requirements, and overall reduced waste and costs.

According to the methodology of embodiments, films may be fabricated using about 40 spray applied monolayers (about 20 total bilayers, where 1 bilayer is a monolayer of each material) of a gold (Au) nanoparticle colloid with about a 2 mM solution of 2-mercaptoethanol as a counterion. In embodiments, rinse water may be changed out for each monolayer to minimize cross-contamination of the cationic and anionic species during film building. Ultra high purity deionized water may be used for the rinsing process.

In embodiments, small “Badger” style airbrushes, both single and double action, may be used for material deposition. Filtered and desiccated feed air may be used to minimize particulate contamination. Absorption times may be in the range of about 30 seconds to about 1 minute prior to rinsing. Drying of sols on a substrate may be observed at longer absorption times, which may affect both the optical and conductive properties of the resulting film. Visual observation may indicate absorption of material onto the substrate.

In order to transition the spray assembly process to large substrates and to minimize material quantities required for coating application, different embodiments may be implemented, based on the material being formed.

In embodiments, spray nozzles may be employed that use minimal material consumption at reasonably produced pressures. For example, a centrifugal pump (e.g. about 0.35 GPM at about 40 psi) having an appropriate spray pattern (e.g. in the range of about 45 degrees to about 120 degrees) may be implemented, in accordance with embodiments. In embodiments, solid cone nozzle may be implemented for adequate coverage, wide dispersion, and/or atomizing. In embodiments, multiple nozzles may be implemented at the same time or succession.

In embodiments, spray nozzle(s) and/or pump combinations may be implemented. For example combination may consider factors such as proper pressure drop at given flow rate, had known flow rates at given pressure for a given spray nozzle, and the number of nozzles. An electric drive centrifugal pump may be implemented with polymer-based parts (e.g. all polymer based parts) for material compatibility.

In embodiments, spray pattern, the effect of distance to target, and/or width of spray, may be considered in conjunction with the size of the spray processing station to obtain substantially complete coverage on a variety of substrate materials and geometries in a calculated manner. In embodiments, a nanoparticle colloid compatibility with a pressure building pump may be a consideration factor. Centrifugal pumps may continually turn and “beat” fluid to maintain pressure and do not shut off once pressure is achieved, but rather continually “chum” the material. Accordingly, in some applications, a centrifugal pump may degrade gold properties, depending on different factors which would be apparent to one of ordinary skill in the art. In embodiments, a positive displacement, air powered diaphragm pump may be implemented, which facilitated dialing of max head pressure for safety and to was capable of maintaining minimum pressure/flow rate for proper spraying. In embodiments, materials used in the construction of a particular pump should be considered when considering compatibility with nanoparticle colloids and functional polymers.

In embodiments, a spray box enclosure design may be implemented. For example, polycarbonate may be used as the material of construction because it is relatively inert and optically transparent to visualize spraying. Waster fluids may be removed through addition of a positive displacement, employing an electric diaphragm pump. A bulkhead location for waste removal may prevent excessive buildup of spent material.

In embodiments, the ability of nozzles to be disconnected may be implemented. The ability to spray smaller samples may be implemented. Embodiments relate to a “clean” design to keep track of material lines and flow paths. Instant tube fittings and color coded polyethylene tubing implemented for rapid replacement of tubing to minimize contaminant buildup, along with ease of transforming spray pattern to accommodate smaller samples (and minimize material consumption) may be implemented in accordance with embodiments. The air supply fed to and integrated with spray system, included a regulator for deadhead pressure setting, outlet pressure gauge, and/or appropriate airline and fittings may be implemented in accordance with embodiments. The solenoid valve may be integrated for on/off control, in accordance with embodiments.

In embodiments, cylindrical polyethylene containers with many, all, or substantially all polyethylene dispensing valves may be implemented for space minimization and/or material compatibility. In embodiments, cylindrical polyethylene containers may be avoided for some gold containers. In embodiments, rectangular polyethylene bins with a panel-mount quick disconnect feed tube that integrates with the air-powered diaphragm pump may be utilized for gold containers.

Spray nozzle configuration/distribution may be selected which allow for consistent coverage while spraying materials. For example, in four nozzle stations, four nozzles each may be constructed and mounted to aluminum control rods which facilitate rotation of spray angle and also permitted sliding of nozzle assemblies closer together or farther apart as required to maintain complete coverage over the substrate, in accordance with embodiments.

In embodiments, spraying operations may be automated. A computer with appropriate software (e.g. Labview software) may be utilized as a control system. The software program may be utilized to facilitate user-friendly control, including total monolayer time, intervals between spraying to maintain wet surface, and manual relay control, in accordance with embodiments. DC firing relays and associated 10 driver boards and/or equipment may be selected and installed to facilitate precise control over spray operations, in accordance with embodiments. In embodiments, dedicated AC circuit may be installed to control the entire spray system. In embodiments, an appropriate electrical distribution blocks may be installed.

Embodiments may implement appropriate spraying schedules and/or related variables integrate a spray-assembly to fabricate homogenous films with the consecutive absorption of substantially consistent individual monolayers (e.g. having little fluctuation in thickness as a function of coated surface area). In accordance with embodiments, the following variables may be adjusted per the specific coating materials to be applied and the geometry of the substrate: (1) nozzle orifice diameter and outlet angle, which control coverage and material usage; (2) number of spray nozzles, which is dependent on substrate geometry; (3) total time to deposit each monolayer of material; (4) number of separate sprays within each material monolayer deposition cycle; (5) duration of each separate spray within each material monolayer deposition cycle; (6) total number of individual monolayers to be spray applied; (7) total number of rinse cycles; (8) duration of each rinse cycle; and/or (9) substrate surface interaction with the spray applied materials. In embodiments, the highest possible levels of surface wetting may be desired for maximum absorption/minimized processing times and most homogenous layer deposition.

As an example implantation of embodiments, a spray assembly of gold nanoparticle colloids onto hemispherical acrylic domes (e.g. a rigid non-planar surface) may implement an aqueous gold nanoparticle colloid combined with about a 2 mM poly(allylamine hydrocholoride) (PAH) aqueous counterion solution. In embodiments, surface functionalization may be performed using a 2 mM aqueous solution of poly(diallyldimethylammonium chloride) (PDDA) and silicon dioxide (SiO₂). Table 1, immediately below, illustrates example parameters for spray assembly of the surface functionalization and gold nanoparticle materials onto the acrylic domes, in accordance with embodiments.

TABLE 1

| | | Number of | Monolayers | Total Volume in |
|---|---|---|---|---|
| Chemical | Time per spray | sprays | (or # rinses) | liters |
| PDDA | 3 | 6 | 7 | 1.68 |
| Water | 15 | 9 | 14 | 25.19 |
| SiO₂ | 3 | 6 | 7 | 1.68 |
| Au Sol | 30 | 3 | 20 | 23.99 |
| Water | 6 | 9 | 20 | 14.40 |
| PAH | 10 | 5 | 20 | 13.33 |

Table 1 above, illustrates a description of example parameters employed for the surface functionalization spray assembly and gold nanoparticle spray assembly onto acrylic dome substrates. The number of monolayers for the Au sol, water, and PAH may vary based on required amount of material deposition. Accordingly, the process represented in Table 1 is merely an example and is not intended to limit other embodiments.

Embodiments may be implemented in a wide range of applications, including, but not limited to highly conductive sensors (strain, pressure, chemical, temperature, etc.) protective packaging for electronics or electronic wiring enclosures, lightning strike protection films and textiles as laminates within composites, covering over paper, photographs, clothing or shelter vehicle textiles, clear protective overlays from the environment to prevent deterioration of sensitive documents; or conductive overlays where needed for mirror-like effect or ESD, EMI shielding, thermal and electrically insulating materials or textiles for windows, homes, clothing, space suits, shelters, vehicles, and inflatable vehicles via reflection, a base material for audio or video magnetic recording tapes, solar and marine applications in sails or hulls, kites and parachutes, electronic/acoustic applications such as electrostatic loudspeakers dielectric in foil capacitors, and morphing materials for aircraft.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising a flexible functional material comprises at least one nano-particle layer and at least one linking agent layer, wherein:
said at least one nano-particle layer is bonded to said at least one linking agent layer, and
at least one of said at least one nano-particle layer and said at least one linking agent layer is deposited by being sprayed.

2. The apparatus of claim 1, wherein the flexible functional material is a flexible conductive material.

3. The apparatus of claim 2, wherein said at least one nano-particle layer comprises conductive nano-size particles.

4. The apparatus of claim 3, wherein said conductive nano-size particles comprises gold nano-size particles.

5. The apparatus of claim 4, wherein said gold nano-size particles comprises gold clusters each having a diameter less than approximately 1000 nanometers.

6. The apparatus of claim 5, wherein said gold nano-size particles comprises gold clusters having a diameter less than approximately 50 nanometers.

7. The apparatus of claim 1, wherein at least one of said at least one nano-particle layer and said at least one nano-particle layer are bonded to a base material.

8. The apparatus of claim 7, wherein:
said at least one nano-particle layer is bonded to said at least one linking agent layer by at least one of electrostatic bonding and covalent bonding; and
at least one of said at least one nano-particle layer and said at least one linking agent layer are bonded to the base material by at least one of electrostatic bonding and covalent bonding.

9. The apparatus of claim 7, wherein:
said at least one linking agent layer is an elastomeric polymer;
individual particles of said at least one nano-particle layer are bonded to sites of the elastomeric polymer; and
at least one of individual particles of said at least one nano-particle layer and sites of the elastomeric polymer are bonded to sites of the base material.

10. The apparatus of claim 7, wherein at least one of said at least one nano-particle layer, said at least one linking agent layer, and the base material is polarized.

11. The apparatus of claim 7, wherein the base material is a flexible material.

12. The apparatus of claim 7, wherein the base material is a substantially rigid material.

13. The apparatus of claim 7, wherein at least one of said at least one nano-particle layer and said at least one linking agent layer are sprayed onto at least one of said at least one nano-particle layer, said at least one linking agent layer, and the base material by spraying a liquid comprising at least one of nano-particles and linking agent material.

14. The apparatus of claim 13, wherein the liquid is a liquid carrier medium comprising the nano-particles.

15. The apparatus of claim 13, wherein the liquid is a liquid carrier medium comprising the linking agent material.

16. The apparatus of claim 1, wherein at least one of said at least one nano-particle layer and said at least one linking agent layer are sprayed onto at least one of said at least one nano-particle layer, said at least one linking agent layer, and the base material by substantially maximizing the consistency of interaction between at least one of said nano-particles and said linking agent materials with at least one of said at least one nano-particle layer, said at least one linking agent layer, and the base material.

17. The apparatus of claim 16, wherein said substantially maximizing the consistency of interaction comprises substantially maximizing the rate of at least one of physisorption and chemisorption of at least one of said nano-particles and said linking agent materials with at least one of said at least one nano-particle layer, said at least one linking agent layer, and the base material without substantially damaging at least one of said nano-particles and said linking agent materials.

18. The apparatus of claim 16, wherein said at least one of said at least one nano-particle layer and said at least one linking agent layer is deposited by being sprayed by at least one of an air powered diaphragm pump and a centrifugal pump coupled to at least one spray nozzle.

19. The apparatus of claim 18 wherein said substantially maximizing the consistency of interaction comprises balancing at least two of:
orifice diameter of said at least one spray nozzle;
outlet angle of said at least one spray nozzle; and
time of deposition of at least one of said at least one linking agent layer and said at least one nano-particle layer.

20. An method comprising forming a flexible functional material, wherein
the flexible functional material comprises at least one nano-particle layer and at least one linking agent layer;
said at least one nano-particle layer is bonded to said at least one linking agent layer, and
said forming comprises at least one of spraying said at least one nano-particle layer and spraying said at least one linking agent layer.

21. The method of claim 19, wherein said forming comprises spraying said at least one nano-particle layer and spraying said at least one linking agent layer.
